(19) United States
(12) Patent Application Publication
(10) Pub. No.: US 2025/0291821 A1
(43) Pub. Date: Sep. 18, 2025

(54) GUIDED PROCESSING OF WORKFLOWS FOR GEOSCIENCE DATA

(71) Applicant: Saudi Arabian Oil Company, Dhahran (SA)

(72) Inventors: Abdulmohsen M. Alali, Dammam (SA); Thierry-Laurent Dominique Tonellot, Montferrier-sur-lez (FR); Robert Smith, Dhahran (SA); Hussain Salim, Dhahran (SA)

(21) Appl. No.: 18/602,680

(22) Filed: Mar. 12, 2024

(51) Int. Cl. G06F 16/332; G06F 16/33

(52) U.S. Cl. CPC G06F 16/3329; G06F 16/3344

(57) ABSTRACT

Data processing systems and processing methods are configured to process geoscience data for a set of different data domains. The data processing systems described herein are configured to unify data sources from the set of different domains to process data in the context of each of the different domains of the set. The data processing system can use data, such as training data or trained model weightings, that are generated when performing a processing workflow in a first domain for updating how a second processing workflow is performed for a second, different domain, and vice versa. The data processing system can improve both processing workflows based on the contexts of the other workflow being performed.

### TECHNICAL FIELD

The present disclosure relates to data processing systems. Specifically, this disclosure relates to processing systems trained for the execution of dynamic processing workflows that process uniqueness geoscience data.

### BACKGROUND

Natural language processing (NLP) includes data processing workflows for artificial intelligence (AI) that are configured to receive text and spoken words (e.g., natural language) as input data, interpret the meaning of the input, and produce an output that is relevant or desired and responsive to the input data, such as providing an answer to a question.

NLP combines computational linguistics, including rule-based modeling of human language, with statistical, machine learning, and deep learning models. These models enable data processing systems to process human language in the form of text or voice data and to parse a semantic meaning from the input, including the intent and sentiment of the entity that generated the input data.

NLP drives computer programs that translate text from one language to another, respond to spoken commands, and rapidly summarize large volumes of text, including in real-time. NLP can be included in enterprise solutions that help streamline business operations, increase employee productivity, and simplify mission-critical business processes.

### SUMMARY

This disclosure describes data processing systems and processing methods that are configured to process geoscience data for a set of different data domains. The data processing systems described herein are configured to unify data sources from the set of different domains to process data in the context of each of the different domains of the set. The data processing system can use data, such as training data or trained model weightings, that are generated when performing a processing workflow in a first domain for updating how a second processing workflow is performed for a second, different domain, and vice versa. The data processing system can improve both processing workflows based on the contexts of the other workflow being performed.

A domain includes a processing context that is typically siloed from other processing contexts. A domain can include a set of particular types of input data, a specific set of models, filters, data ingestion techniques, or other processing workflows, and a set of particular desired output data. For example, a first domain can include a seismic data processing domain. The domain can include one or more sub-domains that are relevant to different data types or classes, such as full waveform sonic data, vertical seismic profiles (VSPs), surface seismic data, thin section data, core image data, and so forth. In another example, a domain can be related to processing logging-while drilling (LWD) data.

A workflow includes one or more data processing operations performed by a data processing system in which the data processing system receives input data, processes the input data, and generates output data. The workflow may include a complex set of processing actions and many sets of inputs and outputs. The workflow can be in real-time or batch. The workflow can be pipelined or parallelized. The workflow can be synchronous with one or more other workflows or asynchronous with the one or more other workflows. The workflow can be part of a larger workflow. Essentially, a workflow refers to a sequence in which a known input is provided to a model or set of models and an output is generated with an expected format or form.

The data processing systems and methods described herein enable one or more of the following advantages. The model described herein is configured to enable machine learning for many domains in which there is a limited amount of training data or hard-to-access training data. In some implementations, the data processing system is configured to enable contextual processing of a set of workflows that are varied such that general models are difficult to implement, and in which obtaining data suitable for training general models is difficult.

The data processing systems and methods described herein overcome limitations in which data of processing workflows are not labeled (e.g., that are not categorized as accepted or rejected). A lack of available labeled data can be a significant challenge for training a model, such as an NLP model or other machine learning model. Without labeled data (however the bias of the data), it becomes difficult for the system to learn which workflows are effective or preferred under different conditions. Moreover, the absence of labels means the system lacks explicit feedback on past workflows' success or failure, making it harder to train models that can accurately predict the effectiveness of a given workflow.

Creating labeled datasets for training purposes can include input of specialists who review and approve existing workflows. However, this approach is not practical due to the time, effort, and expertise required. It may not be feasible or practical to have specialists manually label a significant number of workflows, especially considering the complexity and variability of these workflows. In addition, workflows in geoscience data processing can vary greatly based on factors like acquisition design, data quality, and geological zone. This variability introduces complexity in creating generalized models that can adapt to such a wide range of conditions.

The data processing system is configured to handle additional complexity introduced by metadata. Information on acquisition design, vintage, and geological zones, are usually not explicitly captured in the existing workflows, complicating the ability of the system to learn and make informed recommendations.

To overcome these technical issues, the data processing systems and methods are configured as follows. The data processing system includes a set of global natural language models and large language models to interface with geoscience data across different domains, unifying data sources from these different domains. The models can be hierarchical such that there are global models (e.g., for a domain) and local models (e.g., for a specific user/company). The system is configured to ingest data from these different sources, generalize it, and enable processing workflows to be integrated across different domains.

The data processing system is configured to process a large set of distinct datasets by combining artificial intelligence models with a hierarchical model structure to handle diverse datasets like full waveform sonic, VSP, surface seismic data, thin-sections, and core images.

The data processing system is configured to process non-unique geoscience conditioning workflows. In contrast to deterministic systems, where similar inputs lead to predictable outputs, geoscience data processing is characterized by its variability and complexity. Each dataset has unique characteristics, and the specific expertise and judgment of the user greatly influence the processing outcomes. This inherent variability is handled by the data processing system using workflows and tools that are highly adaptable and personalized, capable of catering to the nuances of each dataset and the individual user's expertise.

Processing workflows for geology and geophysics data are typically outlined in broad general steps. In the context of geophysical data processing, such as full waveform sonic or VSP data, workflows are redefined in several ways. The data processing system automates existing steps and also modifies these steps based on data characteristics and accumulated expert knowledge. Types of workflow redefinition include a customization of workflow steps, intelligent automation, and dynamic sequence adjustment. For customization, workflows are adapted to match the specific characteristics of each dataset, such as its range, resolution, and acquisition environment. For example, the data processing system adjusts parameters within a workflow step (like filter cutoff frequencies) to better suit the data at hand. For intelligent automation the data processing system, is configured to select particular steps to automate based on outcomes feedback. The automation can include choosing the most effective algorithms or processing techniques for a given dataset. For dynamic sequence adjustment, the data processing system can change an order or inclusion of certain steps in a workflow based on the data type or automatic recognition of features in the data. For instance, the system might recommend additional steps for data that exhibits certain characteristics or skip steps that are unnecessary for specific datasets.

In the disclosure, two primary examples including waveform sonic and Vertical Seismic Profile (VSP) data are used to illustrate the data processing system functionality. Similar examples can be carried across geoscience data.

The one or more foregoing advantages can be enabled by one or more of the following embodiments.

In an aspect, a method for guided processing of workflows for geoscience data includes receiving geoscience data describing a subsurface region; identifying a domain of the geoscience data, the domain representing a set of signal features for that geoscience data that are relevant to data processing of the geoscience data; receiving a natural language query specifying a data processing objective to be performed for the geoscience data having the domain, the data processing objective specifying particular output data for generation by a set of processing actions; translating, based on the identified domain, the natural language query, the translating comprising generation of a set of recommendations for processing the geoscience data, the recommendations specifying one or more parameter values; and executing, based on the set of recommendations specifying one or more parameter values, the set of processing actions for processing the geoscience data.

In some implementations, the method includes receiving at least one user input validating the recommendations specifying one or more parameter values; and responsive to the user input, updating the set of processing actions for processing the geoscience data to change at least one processing step to a different processing step.

In some implementations, the method includes updating, based on the user input, a user model associated with the user, the user model linked to a group model and a global model in a model hierarchy, wherein the group model is configured to receive first processing parameters data from a set of user models including the user model based on execution of the set of processing actions for processing the geoscience data for the user model, and wherein the global model is configured to receive second processing parameters data from a set of group models including the group model based on the first processing parameters received by the group model.

In some implementations, the method includes presenting, in a user interface after at least one processing step, a visualization of the geoscience data being processed at the at least one processing step; and receiving, for at least one processing step of the set of data processing actions, an additional natural language query selecting a recommendation of a parameter value for performing the at least one processing step.

In some implementations, the one or more processing actions comprise an executable processing script.

In some implementations, the domain specifies at least one of a source of the geoscience data, a type of the geoscience data, and a type of geoscience represented in the geoscience data.

In some implementations, the signal features represent one or more of a set of statistics on the data such as minimum, maximum, and average values or a frequency spectrum.

In some implementations, the method includes performing data cleansing based on the domain of the of the geoscience data, the data cleansing removing data irregularities the geoscience data that are identified based on the domain.

In some implementations, the method includes integrating the set of data processing actions to be performed by a set of at least two software modules from separate data processing applications.

In some implementations, the method includes determining a format of the geoscience data based on the identified domain.

In some implementations, the one or more parameter values comprise filter configuration parameters.

In some implementations, the one or more recommendations comprise a natural language output listing a set of processing actions for subsequent

In an aspect, a system is configured for a guided processing of workflows for geoscience data. The system includes at least one processor; and a memory storing instructions that, when executed by the at least one processor, cause the at least one processor to perform the methods described herein.

In an aspect, one or more non-transitory computer readable media store instructions for a guided processing of workflows for geoscience data. The instructions, when executed by at least one processor, are configured to cause the at least one processor to perform operations to perform the methods described herein.

The details of one or more embodiments are set forth in the accompanying drawings and the description below. Other features and advantages will be apparent from the description and drawings, and from the claims.

### BRIEF DESCRIPTION OF THE DRAWINGS

FIG. 1 shows an example data processing system including a hierarchical structure.

FIG. 2 shows an example of a data processing workflow.

FIG. 3 shows an example of a data processing workflow.

FIGS. 4A-4B show examples of user interfaces.

FIG. 5 illustrates hydrocarbon production operations.

FIG. 6 is a diagram of an example computing system.

Like reference numbers and designations in the various drawings indicate like elements.

### DETAILED DESCRIPTION

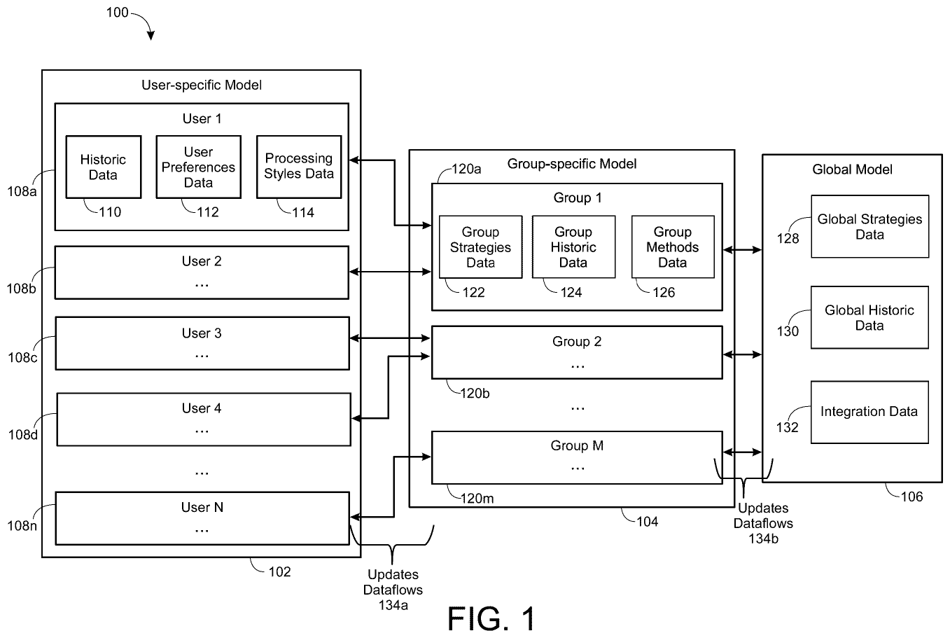

FIG. 1 shows an example data processing system 100 including a hierarchical structure. The data processing system 100 is configured to obtain feedback data from systems and users 108a-n (collectively users 108) at a lower, user-specific model 102. The data processing system can aggregate these feedback data into valuable insight for higher level model, such as a group-specific model 104 and eventually a global model 106. These feedback data, obtained from processing user-specific data by the user-specific model(s) 102, are sent to the group-specific model(s) 104 for groups 120a-m (collectively groups 120) over updates dataflows 134a. Feedback data generated by the group-specific model(s) 104 that process group data at the group level are sent to the global model 106 over updates dataflows 134b.

The data processing system 100 includes a hierarchical model structure with levels including a user model 102, a group model 104, and a global model 106. In some implementations, the global model 106 refers to a model that incorporates data from each domain for a given data processing environment of an entity, such as a company or other organization or institution. In some implementations, the group-specific model 104 refers to one or more models with data for each group of the entity. In some implementations, the group model 104 is the same for each of the groups 120a-m. In some implementations, the group model 104 is unique for one or more of the groups 120a-m. In other words, each group 120a-m, including groups 1 to M, can represent a distinct group model from one or more other group models. In some implementations, the user-specific model 102 refers to one or more models incorporating data for users 108a-n of each group 120a-m the entity. In some implementations, the user model 102 is the same for each of the users 108a-n. In some implementations, the group model 102 is unique for one or more of the users 120a-n. In other words, each user 120a-n, including users 1 to N, can represent a distinct user model from one or more other user models.

The user model 102 contains data for individual users 108 of an entity, such as a company or other organization or institution. capturing their unique expertise, preferences, and processing styles. The user model 102 is dynamic. Specifically, the user model 102 updates based on each user's 108 interactions to reflect developing methodologies and insights of the user. For example, the user model 102 for each user 108 can be trained specifically for that user based on historic data 110, user preferences data 112, and processing styles data 114. The historic data 110 can include representations of data that have been previously processed for that particular user 108a, which can represent trends or baseline data associated with that particular user and assist the training of the model for that particular user. The user preferences data 112 can include values for parameters that the user specifies. For example, the user preferences data may represent calibrations of various data processing aspects of the model by that particular user. The processing styles data 114 can include semantic information particular to a specific user that indicate a form in which the user inputs queries for obtaining perspective outputs. For example, the processing styles data 114 can specify specific language used by a user to initiate respective data processing workflows.

The model for a user 108a-n is configured to adapt to the user's specific needs and learn from user experiences. Specific examples of updates to these models are subsequently described in detail with respect to data ingestion, parameter adjustment and evaluation, domain identification and feature extraction, data capture through NLP queries and related semantic discovery, workflow execution and refinement, and transmission of output/feedback data to higher model levels.

The group-specific model 104 represents a model configured to receive input from multiple users 108. The group-specific model 104 can represent a collective intelligence of a group, such as a department tasked with processing particular data types. A group model 104 for each group 120a-m is trained based on group strategies data 122, group historic data 124, and group methods data 126. The group strategies data 122 includes values of parameters representing specific processing goals or preferences that are specified by members of the group 120. Specifically, the group strategies data 122 represents a combination of user preferences data 112 from each of the users in the group that are combined to form a comprehensive strategy for the group. for example, if each user specifies a specific desired output for processing data for various aspects of the workflow for the group, the group strategies data 122 can specify a list of preferred outputs generated by the group model 104. The group historic data 124 specifies for each of the users in each group 120, a set of trends or other historic information about the data that have been processed for those users. For example, the group historic data 124 may specify maximum and minimum values that have been processed in the past so that the data processing system can establish a nominal range of values for input values or output values for that group 120. In an example, the group model 104 for a given group 120a can process values outside of the expected or historic range differently from those within the historic range specified by the group historic data 124.

The group data 122, 124, and 126 generated from the user models results in a rich repository of group expertise for each group. The group model 104 model facilitates knowledge sharing among team members, ensuring that effective strategies and insights are disseminated throughout the department. The group model 104 is periodically updated (over dataflows 134a) with data from user models 108, ensuring that each of the group models 120a-m remains a current and accurate reflection of the group's capabilities and practices. Specific examples of updates to these models are subsequently described in detail with respect to data ingestion, parameter adjustment and evaluation, domain identification and feature extraction, data capture through NLP queries and related semantic discovery, workflow execution and refinement, and transmission of output/feedback data to higher model levels.

The global model 106 integrates insights from the group models 104 of groups 120a-m, forming the apex of the system's intelligence. The global model 106 includes global strategies data 128, global historic data 120, and integration data 132. The global strategies 128 data includes a combination of the group strategies data 122 from each of the groups 120a-m of the group-specific model 104. The global historic data 130 includes a combination of the group historic data 124 from each of the groups 120a-m. The integration data 132 includes values of parameters that specify how data of each of the groups 120a-m are weighted with respect to one another and combined or the global model 106. The global model 106 sets standards for organizational data processing, encapsulating the company-wide consensus on best practices and effective strategies to overcome unknown biases generated by the lower-level models 102, 104. The global model 106 guides the entity's data processing approaches and ensures consistency across different groups, such as for different departments, and projects. Specific examples of updates to these models are subsequently described in detail with respect to data ingestion, parameter adjustment and evaluation, domain identification and feature extraction, data capture through NLP queries and related semantic discovery, workflow execution and refinement, and transmission of output/feedback data to higher model levels.

In the proposed workflow, the user model is tailored for an individual geoscientist, a user, focusing on seismic data of a fractured zone in a shallow target within a basin, enhancing detection and analysis of key geological features. The department model aggregates insights across the basin from multiple user models, addressing diverse geological complexities and standardizing methodologies for fractured zone analysis. The model synthesizes successful strategies for broader application, enhancing lateral understanding of the basin's challenges. The global model compiles outcomes and strategies from various departments, documenting basin-wide exploration efforts, evaluating data quality, and identifying gaps. The model provides recommendations for future data acquisition and research priorities, ensuring organizational learning and strategic decision-making align with field data insights and exploration objectives. This hierarchical modeling approach ensures efficient data utilization and knowledge transfer from individual analyses to global exploration strategies.

The data processing system 100 is configured to include customized models for each data class. The data processing system 100 includes models that are customized for each specific data class, such as for full waveform sonic, VSP, surface seismic, thin section, core images, etc. The data-specific models ensure that the unique characteristics of each type of data are considered. The customization enables users 108 to maximize the potential of the obtained geoscience data, leading to more accurate imaging and interpretations. The global model 106 can be configured differently depending on whether users are processing seismic data or core samples data, for example. More specifically, for each user 108, a user's configured machine learning models may have been trained to execute in a specific region, type of subsurface, or based on other considerations for processing seismic data. The parameters of these models, including bias values and weighting values, can be combined with other machine learning models developed by other users to determine whether additional accuracy can be obtained across the group (for the group model 104) or entity (for the global model 106). The data processing system can generate tailored models that provide tools and methodologies according to business needs for each data type and respective workflow, such as parameters values for denoising, signal enhancement, reservoir imaging, data interpretation, and so forth.

The generated models are dynamic rather than static. Specifically, each of the user model 102, group model 104, and global model 106 evolve periodically or continuously based on additional updates to machine learning models by individual users in the entity. Specifically, the models are updated based on additional data received and additional training performed from each data interaction and processing outcome. The dynamic evolution ensures that the data processing system 100 is able to adapt to new techniques, datasets, and user feedback for geoscience data processing.

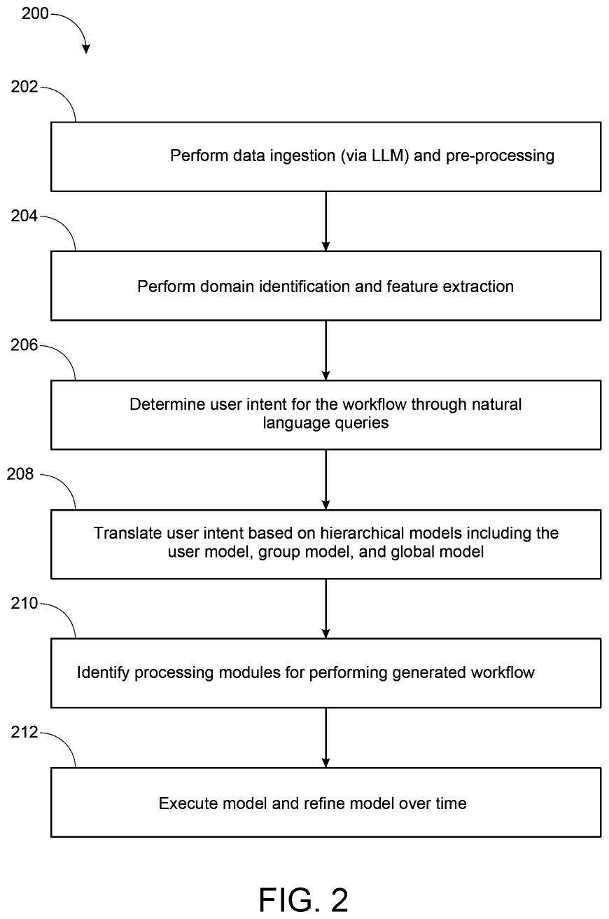

FIG. 2 shows an example process 200 for generating a data processing system workflow using the data processing system of FIG. 1. The workflow generation process 200 in the data processing system is designed to accommodate the non-uniqueness nature of geoscience workflows. In an example, the processing workflow is inherently non-unique and subject to variation; adjusting parameters or functions can lead to satisfactory outcomes. Similarly, achieving an acceptable result with a specific workflow on one dataset does not guarantee success on another. For example, in seismic data processing, the users asks the LLM via the prompt window to load the data, the model loads the data and, identifies the frequency content and the survey location based on the input data. The process involves extracting locations with significant noise, such as ground roll noise, from specific gathers. Then, responding to user prompts, if the user requests suggestions for data processing, the system uses the identified area and the user's hierarchical model to recommend a selection of modules with specific parameters that have proven successful in similar areas (as accepted by this department).

The data processing system generates workflows by performing 202 data ingestion and pre-processing. The data processing system ingests various datasets related to the workflow to be generated and converts them to compatibility. The data processing system is configured to perform normalization of data (such as seismic data, core images data, etc.) and perform extraction of initial metadata, setting the stage for accurate and efficient processing. In an example, a vibration model can be invoked at this stage, in which the data processing system is configured for embedding of the data input and searching in the repository for a similar embedding. This workflow can be division/department oriented and links to the core of data handled by that division. To invoke large scale embedding, the data processing system is at a high level (e.g., a general model). In some implementations, the data processing system ingests various datasets and related information, such as field reports, and converts these datasets for cross-software compatibility for downstream data processing models.

The data processing system 100 is configured to perform (204) domain identification and feature extraction from the pre-processed data. Following data ingestion, the data processing system uses a large language model (LLM) to analyze metadata and content for precise domain identification. For example, a domain can include a seismic data processing domain, seismic data interpretation domain, core and thin section description domain, a pipeline network control domain, well management or placement, and so forth. The domain can include one or more sub-domains that are relevant to different data types or classes, such as full waveform sonic data, vertical seismic profiles (VSPs), surface seismic data, thin section data, core image data, and so forth. In another example, a domain can be related to processing logging-while drilling (LWD) data. The data processing system's selection of a domain determines a direction of subsequent processing actions. The data processing system extracts relevant features tailored to the specific domain of the dataset, ensuring that the subsequent processing is as targeted and effective as possible. For example, for a seismic processing domain, the data processing system can extract faults and facies features from the provided data describing various subsurface and related geophysical data, such as resistivity or porosity data.

The data processing system is configured to determine (206) user intent for the workflow being generated by processing natural language queries. The data processing system receives, from a user, an expression representing user intent through natural language queries. The expression representing a user intent can include, for example, user expressing that the intention is to determine a type of facies present in a particular region of subsurface, generate a seismic image from acoustic data, or perform some other data processing workflow. The data processing system enables users to articulate processing goals and preferences in a way that is intuitive and straightforward. For example, a user's objective can be to denoise a dataset, enhance part of the signal, generate a structural image, identify geological bodies, create a velocity model, and so forth.

The data processing system is configured to translate (208) the natural language queries to determine the user's requirements and determine actionable data processing actions to satisfy the user requirements. The translation process can include understanding nuances of the user's language, specific user objectives, and specific conditions or constraints that are articulated by the user. The data processing system can interpret the natural language queries to ensure that the user's expertise and intentions are accurately reflected in the workflow design of the generated data processing workflow.

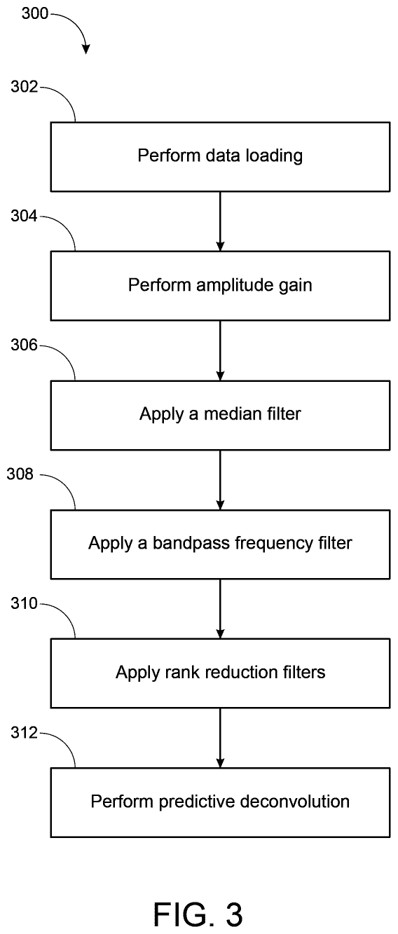

The translation includes a translation of the user's expressed intent into a data processing workflow that is performed by the data processing system 100 of FIG. 1. Once the user's intention is obtained from the query, each model 102, 104, and 106 in the hierarchy interprets the query and generates response data. Specifically, each of the models is configured to generate workflow recommendations with suitable processing parameters values. The data processing system 100 enables users to access the collective expertise embedded in the models 102, 104, and 106 as described previously by generating an improved workflow aligned with the user's processing goals. Specific workflow examples are subsequently described, such as in relation to FIG. 3.

The data processing system can perform the translation by considering various factors such as a source of the dataset, dataset characteristics (sensor types, quality control factors, region, age, etc.), any relevant contextual information (e.g., metadata, field reports, etc.), an expertise of the user, and historical data associated with similar data processing system workflows. The data processing system can suggest a set of tools and algorithms for execution of the workflow, as well as values for relevant parameters, such as denoising filters, sorting criteria, and other specialized tools, that are best suited to help the user achieve the stated and interpreted intention.

The data processing system is configured to perform (210) an integration of different existing software types to perform the processing workflow. The translated workflow is configured to use one or more software packages available for sub-processes within the workflow. Because the data of the workflow have been pre-processed and generalized, the data are accessible for the different software types. The data processing system can integrate a set of array different specialized geoscience processing modules, selecting the best tools from each to create an optimized workflow. The data processing system, by performing this integration, allows the workflow to harness the strengths of different software platforms, providing a comprehensive suite of processing capabilities. In some implementations, the processing modules of different software packages can be selected from a library for integration.

The data processing system is configured to perform data format conversions and interoperability requirements, ensuring a smooth workflow execution across various software platforms. This multi-software integration, guided by the user's natural language queries, results in a workflow that is both robust and tailored to the specific demands of the dataset and the user's goals. The specific reformatting or conversions depend on the particular processing modules included in the workflow.

The data processing system is configured to perform (212) workflow execution and continuous refinement of the workflow. When the workflow is established, the data processing system causes execution of the workflow. The execution is configured to track the user's expressed intent and recommendations derived from the hierarchical models 102, 104, and 106 of FIG. 1. Throughout this process, the data processing system can maintain a continuous multi-level feedback loop, enabling users to monitor execution progress, evaluate effectiveness of each processing step, store intermediate results, visualize the outcome, and perform adjustments as needed. To enhance the model behavior, the data processing system uses reinforcement learning from human feedback and initial ground truth labels (prompt and reply), as subsequently described.

The data processing system uses step-level feedback for refinement. The step-level feedback is a first level of the feedback loop. A users can provide specific feedback on individual steps of the workflow. For example, users can comment on the effectiveness of a denoising step, the accuracy of a data sorting algorithm, or the precision of a geological feature extraction tool.

The data processing system uses the step-level feedback to refine the parameters for subsequent steps within the workflow. Based on the user's input, the data processing system can adjust settings, modify processing algorithms, or even suggest alternative methods for future steps. The level of granularity in feedback ensures that each step of the workflow is optimized and aligned with the user's expectations and the dataset's requirements. The users can directly influence the workflow at the step level to guide the processing of the workflow by the data processing system, ensuring that the workflow remains flexible and responsive to their expertise and the data's evolving interpretation.

The data processing system is configured to receive result-level feedback to refine the workflows. The result-level feedback corresponds to overall conditioning and processing results of the workflow on the dataset. Users can assess the final outcome of the workflow, evaluating the workflow's effectiveness to achieve the intended processing goals and the quality of the data interpretation.

Result-level feedback enables the data processing system to evaluate an overall effectiveness of the workflow. Result-level feedback can enable debugging of the workflow based on determining at which processing modules the workflow excels and at which processing modules the workflow may need improvement to meet the stated processing goal. Result-level feedback enables refinement of a specific project and also assists refinement of the data processing system knowledge base for each of the models 102, 104, and 106.

By collecting and analyzing result-level feedback, the data processing system enhances the knowledge base of the models 102, 104, and 106. The data processing system identifies successful strategies, techniques, and parameters that led to effective outcomes. For example, if a data quality metric exceeded a threshold or if data processing outcomes were within threshold error tolerance, the data processing system can make a note of the particular parameter values used for the processing modules of the workflow that led to the satisfactory result. These parameter values can be stored as part of the knowledge base of one or more of the models 102, 104, and 106. The data processing system uses the updated knowledge to generate future recommendations for workflow processing parameter values, ensuring that the data processing system is continually refined and improved based on real-world user experiences and dataset specifics.

The data processing system 100 is configured for continuous refinement and adaptation. The integration of both step-level and result-level feedback loops allows for continuous refinement and adaptation of the workflow. This dynamic feedback mechanism ensures that the system evolves with each project, learning from the users' experiences and the unique characteristics of each dataset and bias.

The data processing system enables dynamic information flow between models 102, 104, 106. As described previously, information flows dynamically and bidirectionally across this hierarchical structure on dataflows 134a-b. The data processing system integrates knowledge from higher-level models 104, 106 into the user model 102. This integration ensures that broad organizational knowledge and best practices inform individual user 108a-m methodologies, enhancing the efficiency and effectiveness of data processing.

The data processing system refines the user model as now described. The data processing system refines (updates) the user models 102 on the users' 108a-n interactions and decisions within the data processing system. When a user 108a-n engages with the data processing system, especially in designing and executing workflows, the choices and preferences that define a workflow are captured and stored for association with data processing outcomes of that workflow. For example, the choices include the decision to adopt or modify the workflow and parameters recommended by the models. The user can select values for model weights or biases, select models for inclusion or exclusion, and so forth.

The user feedback informs the data processing system 100 about the effectiveness and applicability of the recommended workflows. The user model 102 evolves as workflows are developed by learning from the user's 108a-n decisions and adapting to their unique processing style and expertise. The personalization ensures that the recommendations provided by the data processing system become increasingly aligned with the user's preferences and intended goals over time.

The data processing system performs a periodic update of the group model 104. The group model 104 is periodically updated based on the data generated by the individual user models 108a-n linked to the particular group 120. The data processing system is configured to aggregate he experiences, strategies, and successful practices of various users 108 within the group 120. By synthesizing this information, the group model 104 becomes a repository of the collective intelligence and expertise of the groups 120a-m.

The periodic refinement by the data processing system ensures that the group model 104 remains current and reflective of the latest methodologies and insights of the groups 120a-m. The group model refinement enables a sharing of effective strategies and best practices among group members, enhancing the group's overall capability to process particular datasets.

The data processing system is configured to periodically update the global model 106. The data processing system updates the global model 106 using data from the groups 120a-m of the group model 104. The global model 106 integrated insights and methodologies from across different groups 120a-m.

The data processing system ensures that the global model 106 embodies the entity-wide consensus of best practices and most effective data processing strategies. The global model 106 includes the data processing standards for the entity, guiding the entity's approach to data processing and ensuring consistency and excellence across various projects and groups that each use one or more data processing workflows.

The data processing system enables users to choose how the data processing models 102, 104, and 106 are refined. When a user chooses a workflow for execution, the data processing system can retrieve refinement data from the group model 104 and the global model 106 to update the user model 102 for the user 108a-n. When users select or adapt recommendations originating from higher-level models 104, 106, the users integrate organizational insights into the processing approach of individual workflows. This integration enriches users' personal models 108a-n with a wider range of expertise and methodologies, enhancing future workflow designs and decision-making processes.

The dataflows 134a-b are bidirectional. The data processing system sends insights and experiences data (e.g., feedback data) from individual users 108a-n to the group model 104 and global model 106. This upward flow of information allows the data processing system to evolve and improve periodically or near-continuously, reflecting the real-world experiences and successes of its users 108.

The data processing system allows for user autonomy in the decision-making process. The data processing system provides recommendations data to users 108 based on a wider pool of knowledge, However, the data processing system can allow a user to validate any final decision on which workflow to implement, such as through a user interface.

Examples of the integrations, feedback data, user interfaces data, and refinement processes are now described.

The data processing system integrates with existing systems to identify inefficiencies in processing datasets. In some implementations, geoscience data processing relies on geophysical expertise and custom scripts. Such scripts include shell scripts, function-specific modules, and scripts specifically created for certain types of data and modules. When multiple processing software are used in a workflow, visualizing, and assessing the results can be difficult due to the need for data conversion and the complexity of software user interfaces.

The data processing system identifies and reduces inefficiencies by the following techniques. The data processing system includes a user-friendly natural language interface that allows users to specify their processing goals and data types. The system then translates these inputs into actionable (executable) script and processing actions, based on the data type and characteristics, desired outcome, and user input, minimizing the need for users to understand the underlying code. The data processing system is configured to recognize and adjust to different geophysical data contexts and determine each unique dataset's effective processing scripts and steps. The data processing system can make these decisions based on factors like data resolution, frequency content, and acquisition parameters. The data processing system reduces the learning curve for new users who may not be familiar with the system's specific coding or processing nuances. The model can simplify a processing workflow to make the workflow more accessible and less daunting for those without extensive scripting knowledge. The data processing system enables experienced users to focus on more complex and nuanced aspects of data analysis, enhancing productivity and enabling deeper exploration of the data. For example, experienced users can have configuration details handled automatically for different scripts that have been used in the past. The data processing system adapts to new processing modules and tools. Different software modules can be invoked by the data processing system configured workflow to recommend and execute more efficient and accurate processing flows. The data processing system automates and streamlines integration of different software modules without requiring in-depth knowledge of the respective user interfaces of these modules. The user can use the user interface of the overall workflow.

An example use case for waveform sonic data is now described. This use case is further described in relation to FIG. 3. In this case, the workflow is configured for enhancing a reflected signal in monopole full waveform sonic data. The data processing system performs initial data processing and user feedback by performing the following actions. The data processing system is configured for loading data and applying a band-pass filter. The user loads monopole full waveform sonic data into the system and applies a band-pass filter to enhance the reflected signal. The data processing system performs an observation of the residual Stoneley Waves. The user can note that significant Stoneley waves are still present in the filtered data, indicating that the filter parameters might not be optimal. The data processing system is configured to perform system adaptation based on this feedback. Upon receiving user feedback, the data processing system suggests updating the filter parameters, specifically recommending higher low-cut frequencies to more effectively attenuate the Stoneley waves.

The data processing system performs further filtering and gathers feedback for updating the filters. For example, to address the remaining tube waves, the user suggests applying a median filter.

After applying the median filter, the user can observe that the filter was still not very efficient in filtering out the tube waves. The user can provide additional feedback to the data processing system, hypothesizing that the filter's inefficiency might be due to strong velocity variations in the dataset.

The data processing system can respond to this input and update the workflow. For example, in response to the user's hypothesis, the data processing system suggests visualizing a slowness log to confirm the velocity variation assumption.

The user can confirm or reject the presence of strong velocity variations. The system learns from this interaction that median filters are less efficient in such conditions for future workflows for this application.

The system can perform adaptive recommendations. For example, data processing system can generate filter adjustment suggestions based on this learning. The system can suggest alternative approaches, either decreasing the length of the median filter to better adapt to the velocity variations or exploring time-frequency wavelet transform methods, which might be more effective in such scenarios.

The data processing system is configured to handle user feedback as described in the following examples. Specifically, the data processing system can collect the feedback within the model's interface, ensuring a diverse feedback sources by a design that provides clear guidelines for the feedback. The feedback includes strength and weakness of the model, specific examples, and errors and misunderstandings feedback. The data processing system analyzes the feedback to identify patterns, categorize the feedback, and prioritize the issues that can be addressed with each update iteration and updating the knowledge database.

The data processing system converts the feedback into annotated data. For example, the data processing system pairs each question with feedback that has a greater weight for a desired action. The data processing system classifies the feedback type. The feedback classification can include an explicit correction annotation, rating, and ranking of the answers in which numerical scores/ranking are applied to guide the model.

In some implementations, the feedback updates the user model 102, and these updates are used to update the group and global models 104, 106. The data processing system uses robust labels (which may not yet be 100% accurate) to update a local model, and the local model is used to train a larger model that has a better accuracy.

The data processing system uses various models of data ingestion, selection of which can depend on the type of data being processed. For example, in the context of processing geophysical data, such as seismic recordings and borehole logs, various models of data ingestion are employed to handle the diversity and complexity of the data. The choice of these models often depends on the data source, format, and the specific requirements of the processing system. Additionally, there are standard formats to which data is commonly converted for further processing. Below is a non-limiting list of data ingestion models and data formats that the data processing system can use. The models of data ingestion can include a batch ingestion model that includes uploading large volumes of data at once. This model is typically used when dealing with archival data or datasets retrieved from external storage like hard drives. The batch ingestion model is suitable for historical datasets where real-time data processing is not required.

The models of data ingestion can include a streaming ingestion model. For the streaming ingestion model, data are ingested in real-time or near-real-time as they are generated. The streaming ingestion model is typically useful for live data feeds, such as real-time monitoring of borehole drilling operations. The streaming ingestion model allows immediate analysis and decision-making based on the latest data.

The models of data ingestion can include an application programming interface (API)-based ingestion. The data processing system utilizes APIs to ingest data from various databases or online sources. API-based ingestion can be used when integrating data from different repositories or cloud-based platforms. API-based ingestion facilitates automated and efficient data retrieval from multiple sources.

The models of data ingestion can include a hybrid ingestion model. The hybrid ingestion model includes a combination of batch and streaming models. The hybrid ingestion model approach is often used in scenarios where both historical data and real-time data are relevant for the analysis.

The data processing system ingests data in the following formats for further processing. For example, standard formats for further processing can include SEG (Society of Exploration Geophysicists) data formats. SEG formats include SEG-Y data that are used for storing seismic data. SEG-Y data is a standard seismic trace data format that includes the data and critical header information. SEG formats include the SEG-D format, which is used for field recordings, especially in marine seismic data. SEG formats include LAS (Log ASCII Standard) data. LAS data includes a standard format for borehole logs, including well log data. LAS files can include ASCII text files containing data about the geological formation crossed by a borehole. SEG formats can include DLIS (Digital Log Interchange Standard) data. DLIS is another standard format for borehole logs, including full waveform sonic data. The input data formats can include ASCII and CSV (Comma-Separated Values) data. These data formats are typically used for simpler datasets or when data is exported from databases or spreadsheets. These formats are versatile and easily readable but may require additional formatting for complex data types. The data processing system can also be configured for ingesting proprietary formats. The proprietary formats can be specific to certain software or hardware used in data acquisition. In such cases, conversion tools or adapters may be used to transform data into a compatible standard format for processing.

The data processing system is configured to discover relationships between or among datasets. Examples of similar data for comparison include datasets with similar acquisition design, source, and frequency content. For example, these datasets might involve seismic data collected with the same instrumentation and processing parameters within a defined geographic area. Examples of similar data for comparison include datasets across different types where a specific target is mapped. For example, correlating fracture and fault characteristics observed in VSP and full waveform surveys with corresponding features identified in geology outcrops, well logs, and core samples.

The data processing system is configured to optimize drilling site selection, assess resource potential, and streamline resource management workflows. The data processing system selects particular data and updates workflows by the models described previously as now described. Generally, selecting drilling targets in the oil and gas industry relies on integrating various geology and geophysics data. Integrating various geology and geophysics data can include analyzing seismic surveys to image potential reservoirs, interpreting well logs to assess formation properties, utilizing VSP readings to understand fluid movement, and examining outcrops to confirm seal integrity. Often, valuable insights from nearby wells are also incorporated into the decision-making process. However, depending on the field's stage of development, some data may be unavailable or not effectively shared across all teams, leading to potential inconsistencies and increased risk.

The data processing system addresses these challenges by standardizing the data infrastructure. This includes establishing a unified format for diverse data types, automating real-time updates and analysis, and enabling seamless collaboration across different domains. The data processing system incorporates domain expertise feedback related to each of geologists, geophysicists, petrophysicists, and drilling engineers. The model empowers teams to instantly build upon previous work, leading to more informed target selection and, ultimately, reduced drilling risks.

The data processing system has implemented various models for different tasks. The LLM invokes these models for various tasks provided by the user in the prompt. The data processing system can identify trends in the training and available data and provide recommendations based on these trends.

The data processing system analyzes large datasets using the LLMs. The LLMs can efficiently sift through and analyze vast amounts of environmental data from various sources like satellite imagery (inSar) for CO₂ monitoring, sensor networks, weather stations, and historical records.

The data processing system can detect anomalies. For example, LLMs can be trained to recognize unusual changes in environmental parameters like temperature, precipitation, air quality, or land cover. This can help in early detection of potential environmental events like wildfires, floods, or pollution incidents.

The data processing system can predict future trends. For example, by analyzing historical data and current conditions, LLMs can generate forecasts for future environmental changes. Based on these data, the data processing system can generate workflows that prepare for and mitigate potential risks.

The data processing system is configured to integrate software modules from different software sources, as previously described. Example software modules that are combinable are gathered from software packages commonly used for different geoscience tasks. These include, for seismic data processing, software packages such as VISTA, OMEGA, PARADIGM, LANDMARK SEISMIC, HAMPSONRUSSELL, and GEOTOMO. These can be integrated for tasks ranging from noise reduction to advanced seismic imaging. The data processing system can integrate log processing tools such as TECHLOG, GEOLOG, and WELLCAD are integrated for analyzing well log data, which includes tasks like petrophysical analysis and visual log interpretation. The data processing system integrates software for core analysis. The software can include MOVE, IOLITE, ROCKWORKS, and VIACORE that are used for core sample analysis, structural modeling, and geo-mechanical analysis. The data processing system can integrate thin section analysis software. The data processing system integrates image analysis software such as IMAGEJ, FIJI, MIPAR, and QEMSCAN for detailed analysis of thin section images, including mineralogy and grain size distribution. The data processing system integrates software for seismic data interpretation. The data processing system integrates interpretation software such as PETREL, DECISION SPACE, ESA, and GEOTERIC for seismic data interpretation, integrating seismic data with geological models. To ensure compatibility and seamless integration among these diverse software tools, the system utilizes API-based data exchange when available or transforms data into the standard formats listed previously.

The data processing system ingests data to standardize the formats. The data processing system can resolve inconsistencies such as logical inconsistencies and data errors, and functional inconsistencies in the substance of the data. Ingesting and standardizing data formats in a geoscience data processing system, especially when dealing with diverse datasets like logs, full waveform sonic, VSP, and seismic data, involves resolving various types of inconsistencies. These can range from logical inconsistencies to data errors, and functional inconsistencies in the substance of the data.

The system is designed to automatically recognize the format of incoming data, be it SEG-Y for seismic data, LAS/DLIS for well logs, or any other relevant format from proprietary repositories. The data processing system converts these varied formats into a uniform standard that aligns with the processing tools within the system.

The system also resolves a range of data inconsistencies. For logical inconsistencies, like depth intervals in logs not aligning with seismic time data, the system can employ alignment algorithms to ensure coherence. In the case of data errors, which might include missing values or anomalous spikes, the data processing system can utilize data cleaning techniques. These techniques can filter out noise and correct erroneous data while maintaining the accuracy and integrity of the datasets. Functional inconsistencies, often resulting from equipment malfunctions or recording errors, are also addressed. The data processing system can identify such anomalies through advanced pattern recognition and quality control algorithms. The data processing system flags these anomalies for review, allowing users to make informed decisions about including or excluding this data in the analysis.

The data processing system solicits a user's proficiency and adjusts the user interface accordingly. For novice users, the system provides more conservative recommendations based on widely accepted best practices. The explanations for these recommendations are straightforward, focusing on the practical aspects rather than the underlying technical complexities. The system offers more nuanced recommendations for expert users, possibly including cutting-edge techniques or more complex analytical options. These recommendations are accompanied by in-depth explanations that delve into the technical rationale.

The data processing system generates visualizations, including three-dimensional (3D) visualizations using various datasets. The data processing system generates visualizations, including reports on the data content and additional observations. The data processing system provides a list of processing actions for the workflow being executed with detailed images of the data before and after each processing step.

The users can provide feedback through the user interfaces, as previously described. Generally, user feedback goes beyond simple upvote/downvote actions and is more granular and context-specific, allowing users to provide detailed insights on various aspects of the workflow and outputs.

Users can give feedback in several ways. For example, users can provide feedback using a rating system. Similar to upvote/downvote, users can rate individual steps of the workflow or the overall results. This rating provides a quick, intuitive way to gauge user satisfaction.

Users can provide feedback as comments and suggestions. Users can add comments or suggestions to their ratings. These comments can be about specific parameters users think should be adjusted, alternative approaches they believe might be more effective, or insights into why a particular step worked well or poorly.

Users can provide input for parameter adjustments. Users can suggest specific changes to the workflow's parameters. For example, users might recommend different settings for a data filtering process based on their observations for a specific dataset.

The user feedback influences how the data processing system learns and adapts in several ways. As previously discussed, user feedback enables the data processing system to refine workflow recommendations. If a particular approach consistently receives positive feedback, the model (e.g., a user model 102) will be more likely to suggest it in similar contexts.

The data processing system performs parameter optimization based on the user feedback. For example, the data processing system uses detailed feedback to fine-tune the model's understanding of what settings work best under different conditions. This continual learning helps the system become more accurate and efficient over time. The data processing system generates robust labels with enough basis to refine the model.

The data processing system performs natural language model adjustments. For the natural language aspects of the data processing system, user feedback can inform the development of better user interaction models. If users frequently misunderstand or misinterpret certain instructions or outputs, the language model can be adjusted for clarity and effectiveness. Refinements might involve changing how the data processing system phrases questions and instructions or the way the data processing system interprets user inputs.

The data processing system uses a set of rules for the automation of data preprocessing, cleansing, and integration. The data processing system prepares a dataset for integration with the models as follows. In a scenario where a seismic dataset is being prepared for integration with the models, the data processing system can execute the following actions. The data processing system performs an initial data load into the system. A raw seismic dataset is uploaded into the system. In this example, the data is in SEG-Y format but includes some noise and irregularities. The system performs error identification. The data processing system scans for irregularities, such as sudden spikes, missing values, or dropouts in the signal. The data processing system performs feature extraction. The data processing system computes a set of statistics on the data, such as minimum, maximum, and average values, and extracts features like frequency spectrum, or an interesting geological pattern based on domain knowledge of LLM for the dataset under consideration. The data processing system performs metadata processing. The data processing system extracts key metadata from the seismic data, such as acquisition parameters, geolocation information, and time stamps. The data processing system performs integration with the model. The seismic data are now ready to be integrated with the models for further analysis, such as seismic interpretation or imaging.

The guided execution of workflows enables non-geoscientists (or non-experts for a particular workflow) to perform a data processing system task that an expert is otherwise required to perform. In some implementations, the data processing system can ingest years of workflows processing by dedicated geophysicist to revise the labels enabling finetuning and expertise in LLM to optimize the workflows and guided execution of the workflows.

FIG. 3 shows an example of a data processing workflow 300. Workflow 300 is a specific example of a processing workflow generated based on the data processing system 100 and processes described herein. The processing workflow 300 is configured be a full script that handles a specific noise and submits/tracks it while controlling the quality of the result on the fly. The workflow 300 can be generated using the process 200 previously described. The workflow 300 includes a processing workflow for full-waveform sonic data and can be enhanced by the process 200. The baseline steps include loading data (302), performing (304) amplitude gain, applying (306) a median filter, applying (308) a bandpass frequency filter, applying (310) a rank reduction filter (RSSA), supergrouping, and applying a rank reduction filter (SSA), and performing (312) predictive deconvolution.

The steps in this workflow 300 are typically based on tools and algorithms available in standard seismic processing packages. However, the specific parameters of each of these tools are highly dependent on the type of data (e.g. monopole, dipole, etc.), their recording geometry (number of receivers, source frequency, etc.), the borehole geometry and condition and the expertise of the geophysicist implementing this workflow.

The data processing system modifies the workflow 300 automates the workflow 300 in the following way. For loading data (302), the data processing system automatically deduces the data type and acquisition geometry from the format, naming scheme, and metadata. The data processing system goes a step further by prompting the user to provide additional contextual information such as field reports, well trajectory, and standard well logs. This approach ensures a thorough understanding of the project context, setting the stage for more informed processing decisions.

The data processing system performs (304) amplitude gain. The data processing system suggests a preliminary spike removal step prior to amplitude gain by recognizing the common presence of spikes in full-waveform sonic datasets. The proactive approach is aimed at enhancing data quality before applying amplitude compensation for spherical divergence.

The data processing system applies (306) the median filter. To suppress strong borehole-related noise, the system evaluates the dataset and may recommend sorting the data in a common receiver order before applying the median filter. The data processing system can suggest using a dip filter, providing parameters optimized for the specific dataset based on the initial data context.

The data processing system applies (308) a bandpass frequency filter. With the data context established, the data processing system suggests suitable cutoff frequencies for the bandpass frequency filter. The data processing system removes frequencies unrelated to the reflected signal. The data processing system's recommendations are tailored to maximize signal relevance based on prior workflows, as described previously.

The data processing system applies (310) rank reduction filters and supergrouping. For the RSSA, SSA, and supergrouping phases, which are typically used to improve the signal-to-noise ratio, the data processing system might propose alternative tools based on wavelet transform. These alternatives could potentially offer better performance for the specific data characteristics.

The data processing system performs (312) predictive deconvolution. In a predictive deconvolution step, the data processing system suggests parameters that are most suitable for reducing reverberation noise. These suggestions are based on a thorough analysis of the data's frequency spectrum and the overall data context, as described previously.

Throughout the workflow 300, the data processing system provides appropriate visualizations to help the user evaluate the effect of each tool on the data. The data processing system seeks user feedback at each step, ensuring that the workflow remains aligned with the user's expertise and the specific needs of the dataset. To accomplish this, the data processing system can guide the user at each of steps 302, 304, 306, 308, 310, and 312 of this example workflow 300.

To process full waveform sonic data in workflow 300, the data processing system can guide the user as follows. For action 302, data loading, the data processing system can generate a prompt input: “Please load data from file my_sonic_data.dlis.” The data processing system generates a system action and recommendation. The data processing system identifies the data format, type and context from the user's description. The data processing system recommends additional data uploads, such as well logs or field reports, for comprehensive context building.

For action 304, amplitude gain, the data processing system can generate a prompt input: “The data shows decreasing amplitude with depth. Need to compensate for this.” The data processing system generates a system action and recommendation. The data processing system recommends an amplitude gain function tailored to the depth-related amplitude variation. The data processing system proposes a preliminary noise analysis to check for spike anomalies common in such data.

For action 306, median filter, the data processing system can generate a prompt input: “There's significant borehole noise in the upper sections.” The data processing system generates a system action and recommendation. The data processing system recommends a median filter but also suggests a custom sorting of the data in common receiver order for enhanced noise suppression. The data processing system calculates and recommends optimal filter parameters based on the identified noise characteristics.

For action 308, bandpass frequency filter, the data processing system can generate a prompt input: “I want to focus on the Reflected signal.” The data processing system generates a system action and recommendation. Utilizing the data context and user input, the data processing system suggests specific cutoff frequencies for the bandpass filter that removes frequencies unrelated to the reflected signal.

For action 310, rank reduction filters and supergrouping, the data processing system can generate a prompt input: “Looking to improve clarity and signal strength.” The data processing system generates a system action and recommendation. The data processing system evaluates the effectiveness of rank reduction filters for the dataset. The data processing system might propose a method like singular spectrum analysis (SSA) with parameters optimized for the data's signal-to-noise profile.

For action 312, predictive deconvolution, the data processing system can generate a prompt input: “Need to remove reverberation.” The data processing system generates a system action and recommendation. The data processing system suggests settings for predictive deconvolution, including filter lengths and predictive lags, based on an analysis of the data's reverberation characteristics.

The data processing system can provide continuous interactive feedback throughout the workflow. The data processing system provides visualizations and seeks user feedback after each step. For example, after the median filter application, the data processing system might display a comparison of noise levels before and after the filter, asking for user confirmation or adjustment requests.

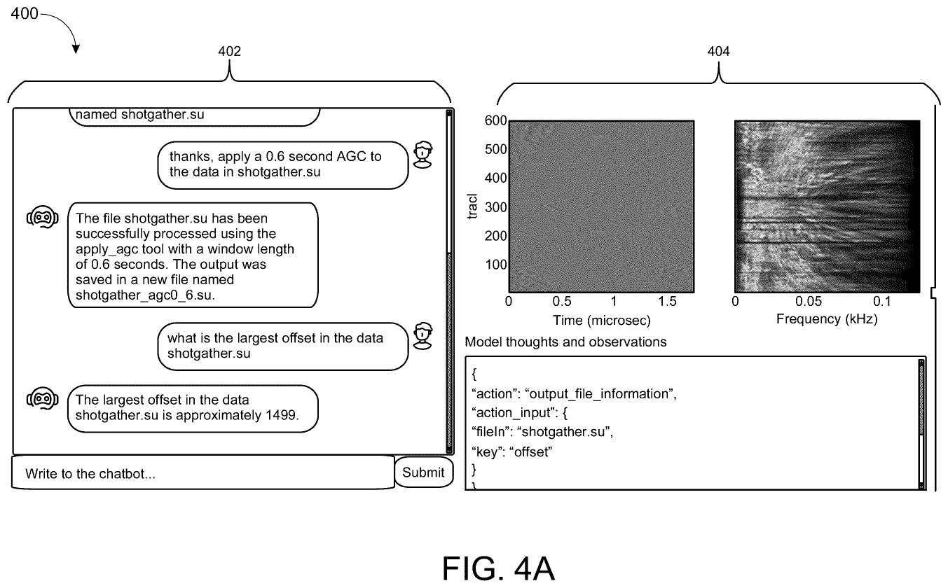

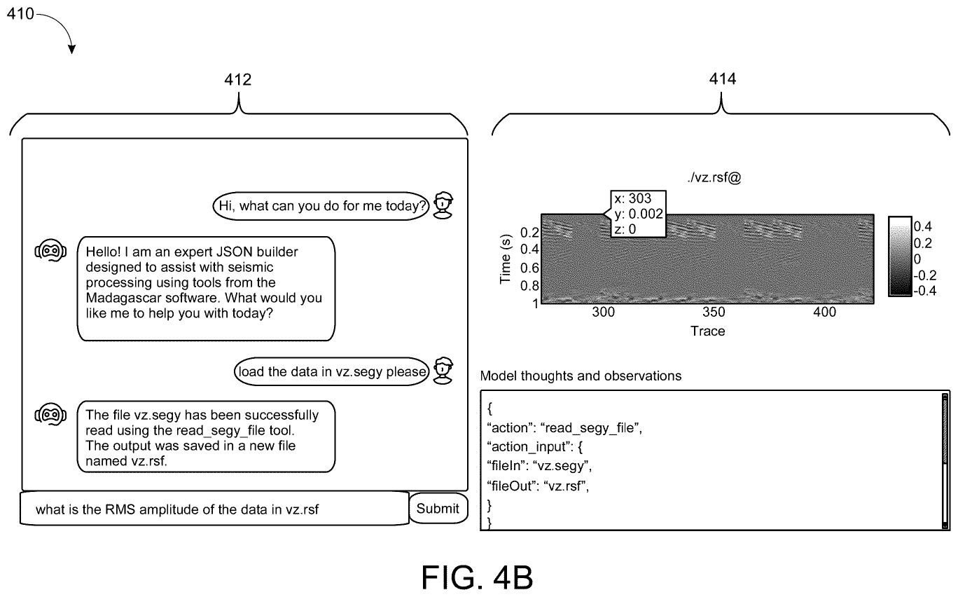

FIGS. 4A-4B show examples of user interfaces 400, 410. Each user interface 400, 410 includes a natural language processing-based user interface 402, 412 and a data panel 404, 414 showing the data being processed in the workflow. User interfaces 400, 410 are examples and are non-illustrative. The exact user interface depends on the data being processed and the corresponding guidance for processing the data that is provided by the data processing system.

The user interfaces 400, 410 of the system are each designed to enhance the user experience significantly. Based on advanced natural language processing (NLP) technology, these interfaces 402, 414 allow users to interact with the system in a more intuitive and natural manner. Users can express their processing requirements and preferences in their own words, and the system interprets these inputs to provide relevant recommendations and workflow options.

This NLP-based interfaces 402, 412 are beneficial in capturing the nuanced requirements of geoscience data processing. These interfaces 402, 412 allow users to articulate processing goals and preferences without being restricted by the limitations of traditional user interfaces. The data processing system's ability to understand and respond to natural language inputs makes it more accessible and user-friendly, especially for users who may not be experts in data processing or programming.

The use of NLP by interfaces 400, 410 also facilitates a more collaborative and interactive processing experience. Users can easily modify and refine their processing requests, and the system responds with updated recommendations and workflows. This interactive dialogue ensures that the system accurately captures the user's intent and provides the most suitable processing solutions.

The NLP also ensures that the a user (e.g., users 108) can provide meaningful feedback on the pertinence and accuracies of the system recommendations, providing invaluable information to help refining the user model.

In some implementations, the user interfaces 400, 410 can include a chatbot that is configured for receiving the natural language query. In some implementations, a chatbot or artificial intelligence agent controller is configured to receive the natural language query and generate responses or prompts for the user using a tuned model (e.g., from the models described in relation to FIG. 1). In some implementations, the interface 400, 410 can generate prompts without needing input from the user, but instead being responsive to events in the data processing workflow. The prompts can include tuned natural language prompts that request an action or input from a user.

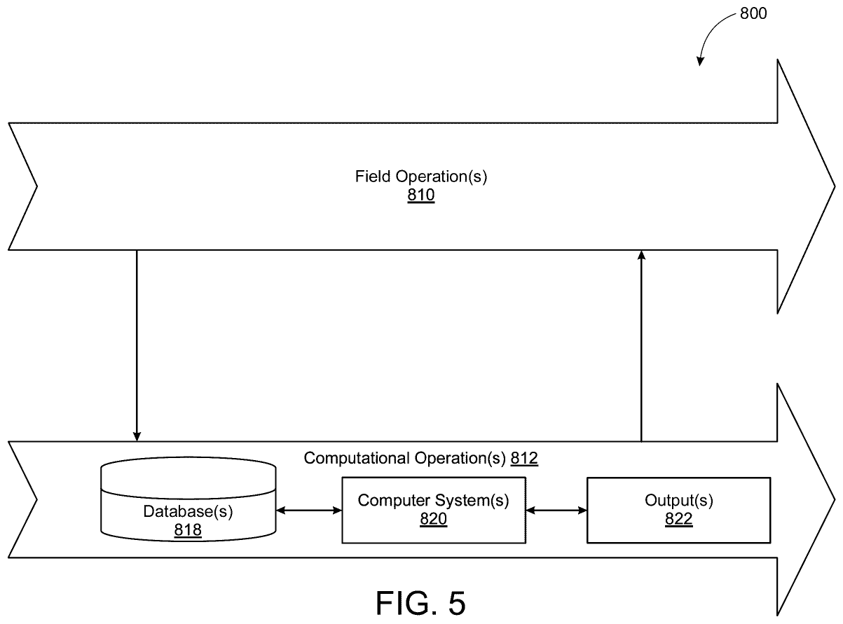

FIG. 5 illustrates hydrocarbon production operations 800 that include both one or more field operations 810 and one or more computational operations 812, which exchange information and control exploration to produce hydrocarbons. In some implementations, outputs of techniques of the present disclosure (e.g., the method 300) can be performed before, during, or in combination with the hydrocarbon production operations 800, specifically, for example, cither as field operations 810 or computational operations 812, or both. For example, the processes 300, 320 collect data during field operations, processes the data in computational operations, and can determine locations to perform additional field operations.

Examples of field operations 810 include forming/drilling a wellbore, hydraulic fracturing, producing through the wellbore, injecting fluids (such as water) through the wellbore, to name a few. In some implementations, methods of the present disclosure can trigger or control the field operations 810. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 810 and responsively triggering the field operations 810 including, for example, generating plans and signals that provide feedback to and control physical components of the field operations 810. Alternatively, or in addition, the field operations 810 can trigger the methods of the present disclosure. For example, implementing physical components (including, for example, hardware, such as sensors) deployed in the field operations 810 can generate plans and signals that can be provided as input or feedback (or both) to the methods of the present disclosure.

Examples of computational operations 812 include one or more computer systems 820 that include one or more processors and computer-readable media (e.g., non-transitory computer-readable media) operatively coupled to the one or more processors to execute computer operations to perform the methods of the present disclosure. The computational operations 812 can be implemented using one or more databases 818, which store data received from the field operations 810 and/or generated internally within the computational operations 812 (e.g., by implementing the methods of the present disclosure) or both. For example, the one or more computer systems 820 process inputs from the field operations 810 to assess conditions in the physical world, the outputs of which are stored in the databases 818. For example, seismic sensors of the field operations 810 can be used to perform a seismic survey to map subterranean features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 812 where they are stored in the databases 818 and analyzed by the one or more computer systems 820.

In some implementations, one or more outputs 822 generated by the one or more computer systems 820 can be provided as feedback/input to the field operations 810 (either as direct input or stored in the databases 818). The field operations 810 can use the feedback/input to control physical components used to perform the field operations 810 in the real world.

For example, the computational operations 812 can process the seismic data to generate three-dimensional (3D) maps of the subsurface formation. The computational operations 812 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 812 to process new information about the formation and control the drilling to adjust to the observed conditions in real-time.

The one or more computer systems 820 can update the 3D maps of the subsurface formation as information from one exploration well is received and the computational operations 812 can adjust the location of the next exploration well based on the updated 3D maps. Similarly, the data received from production operations can be used by the computational operations 812 to control components of the production operations. For example, production well and pipeline data can be analyzed to predict slugging in pipelines leading to a refinery and the computational operations 812 can control machine operated valves upstream of the refinery to reduce the likelihood of plant disruptions that run the risk of taking the plant offline.

In some implementations of the computational operations 812, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 8 s. While the requested data need not be displayed (or initiated for display) instantaneously, it is displayed (or initiated for display) without any intentional delay, accounting for processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart or are in different countries or other jurisdictions.

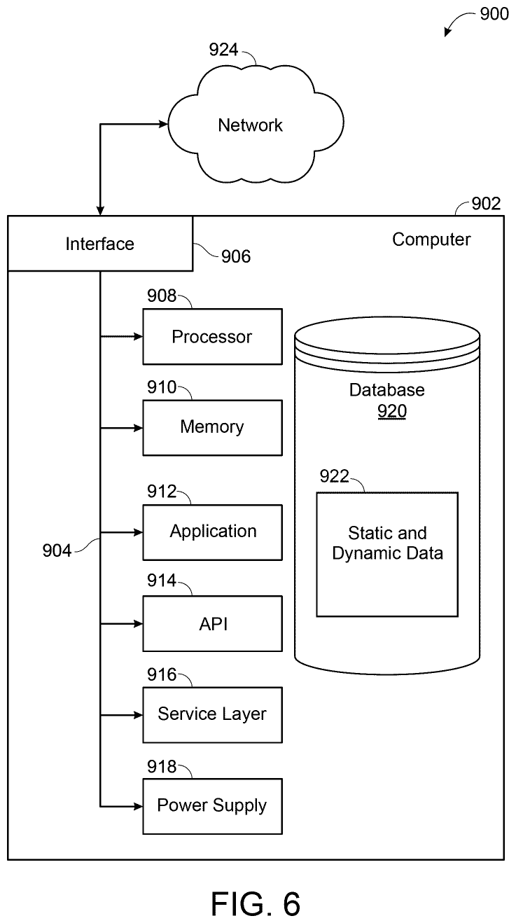

FIG. 6 is a block diagram of an example computer system 900 used to provide computational functionalities associated with described algorithms, methods, functions, processes, flows, and procedures described in the present disclosure, according to some implementations of the present disclosure. The illustrated computer 902 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 902 can include input devices such as keypads, keyboards, touch screens, and microphones that can accept user information. Also, the computer 902 can include output devices that can convey information associated with the operation of the computer 902. The information can include digital data, visual data, audio information, or a combination of information. The information can be presented in a graphical user interface (UI) (or GUI).

The computer 902 can serve in a role as a client, a network component, a server, a database, a persistency, or components of a computer system for performing the subject matter described in the present disclosure. The illustrated computer 902 is communicably coupled with a network 924. In some implementations, one or more components of the computer 902 can be configured to operate within different environments, including cloud-computing-based environments, local environments, global environments, and combinations of environments.

At a high level, the computer 902 is an electronic computing device operable to receive, transmit, process, store, and manage data and information associated with the described subject matter. According to some implementations, the computer 902 can also include, or be communicably coupled with, an application server, an email server, a web server, a caching server, a streaming data server, or a combination of servers.

The computer 902 can receive requests over network 924 from a client application (for example, executing on another computer 902). The computer 902 can respond to the received requests by processing the received requests using software applications. Requests can also be sent to the computer 902 from internal users (for example, from a command console), external (or third) parties, automated applications, entities, individuals, systems, and computers.

Each of the components of the computer 902 can communicate using a system bus 904. In some implementations, any or all of the components of the computer 902, including hardware or software components, can interface with each other or the interface 906 (or a combination of both), over the system bus 904. Interfaces can use an application programming interface (API) 914, a service layer 916, or a combination of the API 914 and service layer 916. The API 914 can include specifications for routines, data structures, and object classes. The API 914 can be either computer-language independent or dependent. The API 914 can refer to a complete interface, a single function, or a set of APIs.

The service layer 916 can provide software services to the computer 902 and other components (whether illustrated or not) that are communicably coupled to the computer 902. The functionality of the computer 902 can be accessible for all service consumers using this service layer. Software services, such as those provided by the service layer 916, can provide reusable, defined functionalities through a defined interface. For example, the interface can be software written in JAVA, C++, or a language providing data in extensible markup language (XML) format. While illustrated as an integrated component of the computer 902, in alternative implementations, the API 914 or the service layer 916 can be stand-alone components in relation to other components of the computer 902 and other components communicably coupled to the computer 902. Moreover, any or all parts of the API 914 or the service layer 916 can be implemented as child or sub-modules of another software module, enterprise application, or hardware module without departing from the scope of the present disclosure.

The computer 902 includes an interface 906. Although illustrated as a single interface 906 in FIG. 6, two or more interfaces 906 can be used according to implementations of the computer 902 and the described functionality. The interface 906 can be used by the computer 902 for communicating with other systems that are connected to the network 924 (whether illustrated or not) in a distributed environment. Generally, the interface 906 can include, or be implemented using, logic encoded in software or hardware (or a combination of software and hardware) operable to communicate with the network 924. More specifically, the interface 906 can include software supporting one or more communication protocols associated with communications. As such, the network 924 or the interface's hardware can be operable to communicate physical signals within and outside of the illustrated computer 902.

The computer 902 includes a processor 908. Although illustrated as a single processor 908 in FIG. 6, two or more processors 908 can be used according to implementations of the computer 902 and the described functionality. Generally, the processor 908 can execute instructions and can manipulate data to perform the operations of the computer 902, including operations using algorithms, methods, functions, processes, flows, and procedures as described in the present disclosure.

The computer 902 also includes a database 920 that can hold data (such as static and dynamic data 922) for the computer 902 and other components connected to the network 924 (whether illustrated or not). For example, database 920 can be in-memory or a database storing data consistent with the present disclosure. In some implementations, database 920 can be a combination of two or more different database types (for example, hybrid in-memory and conventional databases) according to implementations of the computer 902 and the described functionality. Although illustrated as a single database 920 in FIG. 6, two or more databases (of the same, different, or combination of types) can be used according to implementations of the computer 902 and the described functionality. While database 920 is illustrated as an internal component of the computer 902, in alternative implementations, database 920 can be external to the computer 902.

The computer 902 also includes a memory 910 that can hold data for the computer 902 or a combination of components connected to the network 924 (whether illustrated or not). Memory 910 can store any data consistent with the present disclosure. In some implementations, memory 910 can be a combination of two or more different types of memory (for example, a combination of semiconductor and magnetic storage) according to implementations of the computer 902 and the described functionality. Although illustrated as a single memory 910 in FIG. 6, two or more memories 910 (of the same, different, or combination of types) can be used according to implementations of the computer 902 and the described functionality. While memory 910 is illustrated as an internal component of the computer 902, in alternative implementations, memory 910 can be external to the computer 902.

The application 912 can be an algorithmic software engine providing functionality according to implementations of the computer 902 and the described functionality. For example, application 912 can serve as one or more components, modules, or applications. Further, although illustrated as a single application 912, the application 912 can be implemented as multiple applications 918 on the computer 902. In addition, although illustrated as internal to the computer 902, in alternative implementations, the application 912 can be external to the computer 902.

The computer 902 can also include a power supply 918. The power supply 918 can include a rechargeable or non-rechargeable battery that can be configured to be either user- or non-user-replaceable. In some implementations, the power supply 918 can include power-conversion and management circuits, including recharging, standby, and power management functionalities. In some implementations, the power-supply 918 can include a power plug to allow the computer 902 to be plugged into a wall socket or a power source to, for example, power the computer 902 or recharge a rechargeable battery.

There can be any number of computers 902 associated with, or external to, a computer system including the computer 902, with each computer 902 communicating over network 924. Further, the terms “client,” “user,” and other appropriate terminology can be used interchangeably, as appropriate, without departing from the scope of the present disclosure. Moreover, the present disclosure contemplates that many users can use one computer 902 and one user can use multiple computers 902.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random-access memory (RAM), read only memory (ROM), phase change memory (PRAM), static random-access memory (SRAM), dynamic random-access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks.

Several implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Certain features that are described in this specification in the context of separate implementations can also be implemented, in combination, in a single implementation. Conversely, various features that are described in the context of a single implementation can also be implemented in multiple implementations, separately, or in any suitable sub-combination. The separation or integration of various system modules and components in the previously described implementations should not be understood as requiring such separation or integration in all implementations, and the described program components and systems can generally be integrated together in a single product or packaged into multiple products. The previously described example implementations do not define or constrain the present disclosure. Various modifications may be made without departing from the scope of the systems and methods described herein. Accordingly, other embodiments are within the scope of the following claims.

What is claimed is:

1. A method for guided processing of workflows for geoscience data, the method comprising:
receiving geoscience data describing a subsurface region;
identifying a domain of the geoscience data, the domain representing a set of signal features for that geoscience data that are relevant to data processing of the geoscience data;
receiving a natural language query specifying a data processing objective to be performed for the geoscience data having the domain, the data processing objective specifying particular output data for generation by a set of processing actions;
translating, based on the identified domain, the natural language query, the translating comprising generation of a set of recommendations for processing the geoscience data, the recommendations specifying one or more parameter values; and
executing, based on the set of recommendations specifying one or more parameter values, the set of processing actions for processing the geoscience data.

2. The method of claim 1, further comprising:
receiving at least one user input validating the recommendations specifying one or more parameter values; and
responsive to the user input, updating the set of processing actions for processing the geoscience data to change at least one processing step to a different processing step.

3. The method of claim 2, further comprising:
updating, based on the user input, a user model associated with the user, the user model linked to a group model and a global model in a model hierarchy, wherein the group model is configured to receive first processing parameters data from a set of user models including the user model based on execution of the set of processing actions for processing the geoscience data for the user model, and wherein the global model is configured to receive second processing parameters data from a set of group models including the group model based on the first processing parameters received by the group model.

4. The method of claim 1, further comprising:
presenting, in a user interface after at least one processing step, a visualization of the geoscience data being processed at the at least one processing step; and
receiving, for at least one processing step of the set of data processing actions, an additional natural language query selecting a recommendation of a parameter value for performing the at least one processing step.

5. The method of claim 1, wherein the one or more processing actions comprise an executable processing script.

6. The method of claim 1, wherein the domain specifies at least one of a source of the geoscience data, a type of the geoscience data, and a type of geoscience represented in the geoscience data.

7. The method of claim 1, wherein the signal features represent one or more of a set of statistics on the data such as minimum, maximum, and average values or a frequency spectrum.

8. The method of claim 1, further comprising performing data cleansing based on the domain of the of the geoscience data, the data cleansing removing data irregularities the geoscience data that are identified based on the domain.

9. The method of claim 1, further comprising integrating the set of data processing actions to be performed by a set of at least two software modules from separate data processing applications.

10. The method of claim 1, further comprising determining a format of the geoscience data based on the identified domain.

11. The method of claim 1, wherein the one or more parameter values comprise filter configuration parameters.

12. The method of claim 1, wherein the one or more recommendations comprise a natural language output listing a set of processing actions for subsequent performance on the geoscience data based on a current processing status of the geoscience data.

13. The method of claim 1, wherein receiving the natural language query is performed using a natural language input-output interface.

14. The method of claim 1, wherein receiving the natural language query is performed using a chatbot or artificial intelligence agent.

15. The method of claim 1, wherein receiving the natural language query is responsive to generating a prompt to a user, the prompt being tuned using a natural language model.

16. A system for a guided processing of workflows for geoscience data, the system comprising:
at least one processor; and
a memory storing instructions that, when executed by the at least one processor, cause the at least one processor to perform operations comprising:
receiving geoscience data describing a subsurface region;
identifying a domain of the geoscience data, the domain representing a set of signal features for that geoscience data that are relevant to data processing of the geoscience data;
receiving a natural language query specifying a data processing objective to be performed for the geoscience data having the domain, the data processing objective specifying particular output data for generation by a set of processing actions;
translating, based on the identified domain, the natural language query, the translating comprising generation of a set of recommendations for processing the geoscience data, the recommendations specifying one or more parameter values; and
executing, based on the set of recommendations specifying one or more parameter values, the set of processing actions for processing the geoscience data.

17. The system of claim 16, further comprising:
receiving at least one user input validating the recommendations specifying one or more parameter values; and
responsive to the user input, updating the set of processing actions for processing the geoscience data to change at least one processing step to a different processing step.

18. The system of claim 17, further comprising:
updating, based on the user input, a user model associated with the user, the user model linked to a group model and a global model in a model hierarchy, wherein the group model is configured to receive first processing parameters data from a set of user models including the user model based on execution of the set of processing actions for processing the geoscience data for the user model, and wherein the global model is configured to receive second processing parameters data from a set of group models including the group model based on the first processing parameters received by the group model.

19. The system of claim 16, further comprising:
presenting, in a user interface after at least one processing step, a visualization of the geoscience data being processed at the at least one processing step; and
receiving, for at least one processing step of the set of data processing actions, an additional natural language query selecting a recommendation of a parameter value for performing the at least one processing step.

20. One or more non-transitory computer readable media storing instructions for a guided processing of workflows for geoscience data, the instructions, when executed by at least one processor, configured to cause the at least one processor to perform operations comprising:
receiving geoscience data describing a subsurface region;
identifying a domain of the geoscience data, the domain representing a set of signal features for that geoscience data that are relevant to data processing of the geoscience data;
receiving a natural language query specifying a data processing objective to be performed for the geoscience data having the domain, the data processing objective specifying particular output data for generation by a set of processing actions;
translating, based on the identified domain, the natural language query, the translating comprising generation of a set of recommendations for processing the geoscience data, the recommendations specifying one or more parameter values; and
executing, based on the set of recommendations specifying one or more parameter values, the set of processing actions for processing the geoscience data.
